(19) United States
(12) Patent Application Publication
(10) Pub. No.: US 2011/0236639 A1
(43) Pub. Date: Sep. 29, 2011

(54) METHOD OF MAKING AN IMPRINT ON A POLYMER STRUCTURE

(75) Inventors: Mohammad Sultan Mohiddin Saifullah, Singapore (SG); Richard Teng Thuan Khoo, Singapore (SG); Hong Yee Low, Singapore (SG)

(73) Assignee: AGENCY FOR SCIENCE, TECHNOLOGY AND RESEARCH, Centros (SG)

(21) Appl. No.: 13/054,697

(22) PCT Filed: Jul. 17, 2008
(86) PCT No.: PCT/SG2008/000254

§ 371 Date: Jun. 13, 2011

(51) Int. Cl. B32B 3/30; B29C 59/02; B29C 33/42; B82Y 20/00

(52) U.S. Cl. 428/156; 264/293; 425/385; 264/219; 977/902; 977/932

(57) ABSTRACT

There is disclosed a method of making an imprint on a polymer structure comprising the steps of: a) providing an imprinted substrate mold having a defined imprinted surface pattern on a first side and a defined imprinted surface pattern on a second side, opposite to the first side; b) pressing a polymer structure against the first side of the imprinted substrate mold to form an imprint thereon; and c) pressing another polymer structure against the second side of the imprinted substrate mold to form an imprint thereon.

### TECHNICAL FIELD

The present invention generally relates to imprint lithographic methods for making a polymeric structure and to a method for making an imprinted substrate mold for use in imprinting polymers.

### BACKGROUND

Although lithographic methods such as X-ray and election beam lithography have been demonstrated as viable techniques for the fabrication of patterned structures, the serial exposure of a high resolution electron beam pattern is costly and time consuming. The high cost of electron beam exposure systems and the relatively low throughput when high density lithographic exposure patterns are being formed has hindered the use of electron beam lithography in manufacturing processes, particularly as a direct writing microcircuit fabrication tool. Furthermore, electron beam lithographic methods are limited to electron beam-sensitive organic and inorganic materials. Optical lithography has been the predominant patterning technique for high throughput processes. However, the ability to resolve smaller image features is governed by the optical diffraction limits of visible light wavelengths and therefore yields very limited results. Furthermore, such methods may not be cost effective for creating pattern structures below the 150 nm limit and are also limited to the use of light-sensitive organic polymers.

Nanoimprint lithography (NIL) involves the fabrication of nanometer-scale structures and is often used during the fabrication of leading-edge semiconductor integrated circuits. In a known nanoimprint lithography (NIL) process, a thin layer of imprint resist (thermal plastic polymer) is spun coated onto a sample substrate. A hard mold having predefined topological patterns is brought into contact with the substrate and pressed into the polymer coating at a certain pressure and at a temperature above the glass transition temperature of the polymer to allow the pattern on the mold to be pressed into the melt polymer film. After being cooled down, the mold is separated from the sample and the pattern resist is left on the substrate. A pattern transfer process, such as reactive ion etching (RIE) is used to transfer the pattern in the resist to the underneath substrate by removal of residue from the substrate.

Molds need to be mechanically, chemically and thermally stable to resist the pressures and temperatures used in nanoimprint lithographic techniques. However, the use of hard molds in conventional nanolithography has often led to a number of problems inherent to their physical properties, thus reducing their efficiency in NIL methods. For example, the stiffness property of hard molds often results in mold breakage if a high pressure is not homogeneously applied.

A number of methods have been undertaken with the objective of improving the throughput of NIL techniques. These techniques include the use of multiple dispensing nozzles, optimizing the demolding temperature and choice of molecular weight of polymer resist.

Another method to increase high throughput of NIL techniques involves increasing the pattern area horizontally by increasing the mold size. However, this often leads to non-uniform pressure distribution when the size limit is reached. Small size molds are used in a step and repeat lithography technique to increase throughput and to cover a larger wafer substrate. However, it would be desirable if the throughput could be increased.

There is a need to provide an improved method of making an imprint on a polymer structure that overcomes, or at least ameliorates, one or more of the disadvantages described above.

There is a need to provide a method of making an imprinted substrate mold that is capable of imprinting at least two polymers simultaneously.

### SUMMARY

According to a first aspect of the invention, there is provided a method of making an imprint on a polymer structure comprising the steps of:
a) providing an imprinted substrate mold having a defined imprinted surface pattern on a first side and a defined imprinted surface pattern on a second side, opposite to the first side;
b) pressing a polymer structure against the first side of the imprinted substrate mold to form an imprint thereon; and
c) pressing another polymer structure against the second side of the imprinted substrate mold to form an imprint thereon.

Advantageously, the use of a double-sided imprinted substrate mold may increase the production of imprinted polymers when the pressing steps occur simultaneously for a partially period of the pressing time and by two fold when the pressing steps occur simultaneously. Accordingly, at least two formed polymer imprints can be produced at the same time.

Advantageously, the methods disclosed herein avoid the need for additional equipment or processes, as only a single double-sided imprinted substrate mold is required to improve the throughput, potentially by 100%.

In one embodiment, there is provided a method of making a nano-sized or micro-sized imprint on a polymer structure comprising the steps of:
a) providing an nano-sized or micro-sized imprinted substrate mold having a defined imprinted surface pattern on a first side and a defined imprinted surface pattern on a second side, opposite to the first side;
b) pressing a polymer structure against the first side of the nano-sized or micro-sized imprinted substrate mold to form a nano-sized or micro-sized imprint thereon; and
c) pressing another polymer structure against the second side of the nano-sized or micro-sized imprinted substrate mold to form a nano-sized or micro-sized imprint thereon.

According to a second aspect of the invention, there is provided a method of making a double-sided imprinted substrate mold comprising the steps of:

a) pressing a mold having a defined imprinted surface pattern against a first side of a substrate to form a first-sided imprint mold on the substrate; and

b) pressing another mold having a defined imprinted surface pattern against a second side, opposite to the first side, of said substrate to form a second-sided imprint mold on the substrate to thereby form the double-sided imprinted substrate mold.

In one embodiment there is provided a method of making a double-sided nano-sized or micro-sized imprinted substrate mold comprising the steps of:
a) pressing a mold having a defined nano-sized or micro-sized imprinted surface pattern against a first side of a substrate to form a first-sided nano-sized or micro-sized imprint mold on the substrate; and
b) pressing another mold having a defined nano-sized or micro-sized imprinted surface pattern against a second side, opposite to the first side, of said substrate to form a second-sided nano-sized or micro-sized imprint mold on the substrate to thereby form the double-sided nano-sized or micro-sized imprinted substrate mold.

According to a third aspect of the invention, there is provided a method for manufacturing an imprinted polymer structure comprising the steps of:

a) pressing a mold having a defined imprinted surface pattern against a first side of a substrate to form a first-sided imprint mold on the substrate;
b) pressing another mold having a defined imprinted surface pattern against a second side, opposite to the first side, of said substrate to form a second-sided imprint mold on the substrate and thereby form the double-sided imprinted substrate mold;
c) pressing a polymer structure against a first side of the double-sided imprinted substrate mold to form an imprint thereon; and
d) pressing another polymer structure against the second side of the double-sided imprinted substrate mold to form an imprint thereon.

In one embodiment, there is provided a method for manufacturing a nano-sized or micro-sized imprinted polymer comprising the steps of:

a) pressing a mold having a defined nano-sized or micro-sized imprinted surface pattern against a first side of a substrate to form a first-sided nano-sized or micro-sized imprint mold on the substrate;

b) pressing another mold having a defined nano-sized or micro-sized imprinted surface pattern against a second side, opposite to the first side, of said substrate to form a second-sided nano-sized or micro-sized imprint mold on the substrate and thereby form the double-sided imprinted substrate;

c) pressing a polymer structure against a first side of the double-sided nano-sized or micro-sized imprinted substrate mold to form a nano-sized or micro-sized imprint thereon; and

d) pressing another polymer structure against the second side of the double-sided nano-sized or micro-sized imprinted substrate mold to form a nano-sized or micro-sized imprint thereon.

According to a fourth aspect of the invention, there is provided an imprinted polymer structure, the imprinted polymer structure made in a method comprising the steps of:

a) providing an imprinted substrate mold having a defined imprinted surface pattern on a first side and a defined imprinted surface pattern on a second side, opposite to the first side;

b) pressing a polymer structure against the first side of the imprinted substrate mold to form an imprint thereon; and

c) pressing another polymer structure against the second side of the imprinted substrate mold to form an imprint thereon.

In one embodiment, there is provided a nano-sized or micro-sized imprinted polymer structure made in the method defined above.

According to a fifth aspect of the invention, there is provided an imprinted polymer structure, the imprinted polymer structure made in a method comprising the steps of:

a) pressing a mold having a defined imprinted surface pattern against a first side of a substrate to form a first-sided imprint mold on the substrate;

b) pressing another mold having a defined imprinted surface pattern against a second side, opposite to the first side, of said substrate to form a second-sided imprint mold on the substrate and thereby form the double-sided imprinted substrate mold;

c) pressing a polymer structure against a first side of the double-sided imprinted substrate mold to form an imprint thereon; and

d) pressing another polymer structure against the second side of the double-sided imprinted substrate mold to form an imprint thereon.

In one embodiment, there is provided a nano-sized or micro-sized imprinted polymer structure made in the method defined above.

According to a sixth aspect of the invention, there is provided a double-sided imprinted substrate mold, the double-sided imprinted substrate mold made in a method comprising the steps of:

a) pressing a mold having a defined imprinted surface pattern against a first side of a substrate to form a first-sided imprint mold on the substrate; and

b) pressing another mold having a defined imprinted surface pattern against a second side, opposite to the first side, of said substrate to form a second-sided imprint mold on the substrate to thereby form the double-sided imprinted substrate mold.

In one embodiment, there is provided a double-sided nano-sized or micro-sized imprinted substrate mold made in the method defined above.

According to a seventh aspect of the invention, there is provided use of a double-sided imprinted substrate mold for imprinting at least two polymer structures.

In one embodiment, there is provided a use of a double-sided nano-sized or micro-sized imprinted substrate mold for imprinting at least two nano-sized or micro-sized polymer structures.

### DEFINITIONS

The following words and terms used herein shall have the meaning indicated:

The term “nano-size” refers to a structure having a thickness dimension in the nano-sized range of about 1 nm to less than about 1 micron.

The term “micro-sized” refers to a structure having a thickness dimension in the micro-sized range of about 1 micron to about 10 micron.

The term “mold” disclosed herein generally refers to a mold structure or a master mold that is used for shaping or fabrication of a specific article or product. Exemplary molds include but are not limited to silicon, metal, ceramic, polymeric and combinations thereof.

The term “pressing” in the context of this specification may refer to one body pressing against another body, or vice versa, or both bodies approaching each other at the same time to impart a compressive force. For example, the term “pressing A against B” would not only cover body A pressing against body B but would also cover body B pressing against body A and both body A and B pressing against each other.

The term “polymer” as used herein denotes a molecule having two or more units derived from the same monomer component, so that the “polymer” incorporates molecules derived from different monomer components to form copolymers, terpolymers, multi-component polymers, graft-co-polymers, block-co-polymers, and the like.

The term “halogenated polymer” refers to a polymer which has at least one halogen, such as fluorine or chlorine, in the repeating monomer units of the polymer.

The term “fluorinated polymers” refers to a halogenated polymer that has fluorine as a halogen, but may include other halogents. The term covers homopolymers or copolymers derived at least in part from olefinic monomers substituted by fluorine atoms, or substituted by a combination of fluorine atoms and at least one chlorine, bromine or iodine atom per monomer.

The term “substrate” as used herein generally refers to any supporting structure that is used as a template to form two or more polymer imprints. Exemplary substrates include but are not limited to polytetrafluoroethylene (PTFE), ethylene tetrafluoroethylene (ETFE), perfluoroalkyl (PFA), hexafluoropropylene, chlorotrifluoroethylene, bromotrifluoroethylene and combinations thereof.

The term “surface pattern” as used herein generally refers to an outer peripheral surface of any structure disclosed herein.

The term “spin-coating” or grammatical variations thereof as used herein generally refers to a process wherein a polymer solution is dispersed on a surface (e.g., a mold) and the surface is rapidly spun centrifugally forcing the solution to spread out and forming a thin layer of de-solvated polymer in the process.

The term “substantially” does not exclude “completely”. For example, when the pressing steps (c) and (d) are formed “substantially simultaneously”, the pressing steps may be completely simultaneously to thereby produce both polymeric structures during the same time period in a single step. Where necessary, the term “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

### DETAILED DISCLOSURE OF EMBODIMENTS

Exemplary, non-limiting embodiments of a method for making an imprint on a polymer will now be disclosed.

In one embodiment, there is provided a method for manufacturing a nano-sized or micro-sized imprinted polymer structure comprising the steps of:

a) pressing a mold having a defined nano-sized or micro-sized imprinted surface pattern against a first side of a substrate to form a first-sided nano-sized or micro-sized imprint mold on the substrate;

b) pressing another mold having a defined nano-sized or micro-sized imprinted surface pattern against a second side, opposite to the first side, of said substrate to form a second-sided nano-sized or micro-sized imprint mold on the substrate and thereby form the nano-sized or micro-sized double-sided imprinted substrate mold;

c) pressing a polymer structure against a first side of the double-sided nano-sized or micro-sized imprinted substrate mold to form a nano-sized or micro-sized imprint thereon; and

d) pressing another polymer structure against the second side of the double-sided nano-sized or micro-sized imprinted substrate mold to form a nano-sized or micro-sized imprint thereon,

wherein the pressing steps (c) and (d) are formed substantially simultaneously to thereby produce both polymeric structures during the same time period in a single step.

In one embodiment, the method may further comprise, after the pressing step d), the step of simultaneously separating said formed polymer imprints from said imprinted substrate mold.

In one embodiment, the pressing step (a) and said pressing step (b) may occur simultaneously.

In one embodiment, the method may further comprise, after the pressing step (b), the step of separating the double-sided imprinted substrate mold from said molds.

The double-sided imprinted substrate mold can be used for subsequent imprinting and can improve the throughput of production of the polymeric structures. In one embodiment, the double-sided imprinted substrate mold can be used for subsequent imprinting more than once.

In one embodiment, the substrate disclosed herein may be comprised of halogenated polymer. In another embodiment, the halogenated polymer may comprise a fluorinated polymer. Exemplary fluorinated polymers may include polytetrafluoroethylene (PTFE), ethylene tetrafluoroethylene (ETFE), perfluoroalkyl (PFA), fluorinated ethylene-propylene copolymer (FEP), polyvinylidene fluoride (PVDF), polychlorotrifluoroethylene (PCTFE), hexafluoropropylene, chlorotrifluoroethylene and bromotrifluoroethylene.

In one particular embodiment, the fluorinated polymer may comprise ethylene tetrafluoroethylene (ETFE).

Advantageously, the fluorinated polymer can be mechanically conformable, thermally stable and highly resistant to chemicals. In particular, the ETFE polymer is malleable at lower pressures (i.e. about 1 MPa to about 3 MPa) such that it conforms to the shape of the mold. This may effectively reduce wear and tear of the fluorinated mold when it is being used at lower pressures. Hence, the substrate is highly imprintable and can allow various imprintable substrates to be easily fabricated with high accuracy. Advantageously, fluorinated polymers having a relatively low crystallinity are preferred as they are easier to mold. For example, ETFE is relatively easy to process as compared to PTFE, due to the higher crystallinity of PTFE.

Advantageously, it may not be necessary to coat an anti-adhesive layer on the substrate surface due to its low surface energy for easy substrate release from the polymer imprints. Accordingly, the double-sided imprinted substrate may be suitable for subsequent imprintings of polymer structures due to its ability to be malleable at lower pressures and to distribute the applied pressure over the imprint area and thereby conform to the shape of the mold.

In one embodiment, the thickness of the substrate disclosed herein may be in the range selected from the group consisting of about 0.25 mm to about 1 mm; about 0.35 mm to about 1 mm; about 0.5 mm to about 1 mm; about 0.8 mm to about 1 mm; about 0.25 mm to about 0.8 mm; about 0.25 mm to about 0.6 mm; about 0.25 mm to about 0.45 mm; and about 0.25 mm to about 0.5 mm. Hence, in a particular embodiment, the thickness of said substrate may be in the range of about 0.25 mm to about 0.5 mm.

In one embodiment, the imprint of the double sided substrate comprises a plurality of channel formations. Each channel formation being defined between a pair of projections extending from the base of the substrate, each projection having a length dimension extending along a longitudinal axis, a height dimension and a width dimension normal to the longitudinal axis. The width dimension of the plurality of projections may be in the range of about 250 nm to about 3000 nm or about 400 nm to about 2000 nm. In one particular embodiment, the width of the channels is about 250 nm to about 2000 nm.

In one embodiment, the width of said imprinted polymer structure disclosed herein may be in the range of about 250 nm to about 3000 nm or about 400 nm to about 2000 nm. In one particular embodiment, the width of the channels is about 250 nm to about 2000 nm.

In one embodiment, the defined imprinted surface pattern of the first mold may be identical to, or distinct from, the defined imprinted surface pattern of the second mold. Hence in one particular embodiment, the defined imprinted surface pattern of the first mold may be distinct from the defined imprinted surface pattern of the second mold. Advantageously, the use of the first mold having a defined imprinted surface pattern distinct from that of the second mold allows a double-sided substrate mold to be imprinted, having a defined imprinted surface pattern on the first side that is distinct from the defined imprinted surface pattern on the opposite side.

Accordingly, the double-sided imprinted substrate mold disclosed herein may allow at least two different types of polymer structures to be imprinted in a single imprint process.

In one embodiment, the polymer disclosed herein may comprise a thermoplastic polymer. Exemplary thermoplastic polymers include, but are not limited to, polymers selected from the group consisting of acrylonitrile butadiene styrene (ABS), acrylic, celluloid, ethylene-vinyl acetate (EVA), ethylene vinyl alcohol (EVAL), fluoroplastics, liquid crystal polymer (LOP), polyacetal (POM or acetal), polyacrylonitrile (PAN or Acrylonitrile), polyamide-imide (PAI), polyaryletherketone (PAEK or Ketone), polybutadiene (PBD), polycaprolactone (PCL), polychlorotrifluoroethylene (PCTFE), polyethylene terephthalate (PET), polycyclohexylene dimethylene terephthalate (PCT), polyhydroxyalkanoates (PHAs), polyketone (PK), polyester, polyethylene (PE), polyetheretherketone (PEEK), polyetherimide (PEI), polyethersulfone (PES), polyethylenechlorinates (PEC), polylactic acid (PLA), polymethylpentene (PMP), polyphenylene oxide (PPO), polyphenylene sulfide (PPS), polyphthalamide (PPA), polysulfone (PSU), polyvinylidene chloride (PVDC), spectralon, polymethyl methacrylate (PMMA), polycarbonate (PC), polyvinylacetate (PVAc), Biaxially Oriented Poly Propylene (BOPP), polystyrene (PS), polypropylene, High-Density Polyethylene (HDPE), poly(amides), polyacryl, poly(butylene), poly(pentadiene), polyvinyl chloride, polyethylene terephthalate, polybutylene terephthalate, polysulfone, polyimide, cellulose, cellulose acetate, ethylene-propylene copolymer, ethylene-butene-propylene terpolymer, polyoxazoline, polyethylene oxide, polypropylene oxide, polyvinylpyrrolidone, and combinations thereof; an elastomer, polymer blend and copolymer selected from the group consisting of poly-dimethylsiloxane (PDMS), poly(isoprene), poly(butadiene), and combinations thereof. In one particular embodiment, the polymer may comprise polymethyl methacrylate (PMMA).

In one embodiment, the mold disclosed herein may be comprised of any suitable material that is chemically inert to said polymer and is capable of being surface treated. Exemplary molds may be comprised of a material selected from the group consisting of silicon, metal, ceramic, polymeric and combinations thereof. Hence in one particular embodiment, the mold may comprise silicon.

In one embodiment, the process comprises the step of spin coating the polymer onto a wafer. In another embodiment, the wafer may comprise silicon.

In one embodiment, the area of the defined surface pattern on the double-sided imprinted substrate is in the range selected from about 1 cm×1 cm to about 1.5 cm×1.5 cm. In one particular embodiment, the area of the defined surface pattern on the double-sided imprinted substrate is about 1 cm×1 cm. Advantageously, a uniform imprint is obtained on the surface of the double-sided imprinted substrate.

In one embodiment, there is provided a method of making an imprint on a polymer structure wherein the temperature condition during the pressing steps c) and d) is above the glass transition temperature (Tg) of the polymer structure. In one embodiment, there is provided a method of making an imprint on a polymer structure wherein the temperature condition during the pressing steps c) and d) may be in the range selected from the group consisting of about 50° C. to about 200° C.; about 100° C. to about 200° C.; about 50° C. to about 200° C.; about 50° C. to about 150° C.; and 50° C. to about 100° C. Hence, in one particular embodiment, the temperature condition during the pressing steps c) and d) is about 120° C. to about 180° C. In yet another embodiment, the temperature condition during the pressing steps c) and d) is about 140° C. to about 150° C. In one embodiment, there is provided a method of making an imprint on a polymer structure wherein the pressure condition during the pressing steps c) and d) may be in the range selected from the group consisting of about 0.25 MPa to about 3 MPa; about 0.5 MPa to about 3 MPa; about 0.5 MPa to about 3 MPa; about 0.25 MPa to about 2.5 MPa; 0.25 MPa to about MPa; and about 0.25 MPa to about 1.5 MPa. In one particular embodiment, the pressure condition during pressing steps c) and d) is about 1 MPa to about 3 MPa. Advantageously, the double-sided imprinted substrate mold can be used to imprint the polymer structures at low pressures, as it is highly conformable at low pressures.

In one embodiment, there is provided a method of making an imprint on a polymer structure wherein the time condition during the pressing steps c) and d) may be in the range selected from the group consisting of about 1 minute to about 20 minutes; about 1 minute to about 15 minutes; about 1 minute to about 10 minutes; about 2 minutes to about 10 minutes; and about 2 minutes to about 5 minutes. In one particular embodiment, the time condition during the pressing steps c) and d) is about 2 minutes to about 6 minutes.

The double-sided imprinted substrate mold that is used in pressing steps c) and d) can be used for subsequent imprinting of polymer structures. In one embodiment, the double-sided imprinted substrate mold can be used for subsequent imprinting. For example, to increase the reusability of the double-sided imprinted substrate mold, the pressing steps c) and d) may be operated at low temperature and pressure at about 170° C. and about 1 MPa or less. Furthermore, to maintain the integrity of the double-sided imprinted substrate mold during pressing steps c) and d), the pressure can be reduced to 1 MPa or less, when the operating temperature increases to above 100° C.

In one embodiment, there is provided a method of making a double-sided imprinted substrate wherein the temperature condition during the pressing steps (a) and (b) may be in the range selected from the group consisting of about 150° C. to about 300° C.; about 200° C. to about 300° C.; and about 150° C. to about 250° C. In one particular embodiment, the temperature condition during the pressing steps (a) and (b) is about 200° C. to about 220° C.

In one embodiment, there is provided a method of making a double-sided imprinted substrate wherein the pressure condition during the pressing steps (a) and (b) may be in the range selected from the group consisting of about 1 MPa to about 10 MPa; and about 1 MPa to about MPa. In one particular embodiment, the pressure condition during the pressing steps c) and d) is about 3 MPa to about 6 MPa.

In one embodiment, there is provided a method of making a double-sided imprinted substrate wherein the time condition during the pressing steps (a) and (b) may be in the range selected from the group consisting of about 10 minutes to about 30 minutes; about 10 minutes to about 25 minutes; about 10 minute to about 20 minutes; and about 10 minutes to about 15 minutes; In one particular embodiment, the time condition during the pressing steps c) and d) is about 10 minutes to about 30 minutes.

In one embodiment, the method of making an imprint on a polymer structure may further comprise the step of allowing the formed two or more polymer imprints to cool to an imprinted substrate release temperature range, prior to the step of separating the formed polymer imprints from the imprinted substrate. The imprinted substrate release temperature may be in the range selected from the group consisting of about 25° C. to about 80° C.; about 25° C. to about 75° C.; about 25° C. to about 60° C.; about 25° C. to about 45° C.; about 30° C. to about 80° C.; about 45° C. to about 80° C.; about 65° C. to about 80° C.; and about 70° C. to about 80° C. In one particular embodiment, the substrate release temperature may be about 80° C. Advantageously, a lower release temperature allows easy separation of the imprinted polymer structures from the imprinted substrates.

In one embodiment, the method of making a double-sided imprinted substrate may further comprise the step of allowing the imprinted substrate to cool to a mold release temperature range, prior to the step of separating the imprinted substrate from the molds. The mold release temperature may be in the range selected from the group consisting of about 25° C. to about 70° C.; about 25° C. to about 65° C.; about 25° C. to about 55° C.; about 25° C. to about 40° C.; about 30° C. to about 70° C.; about 45° C. to about 70° C.; about 55° C. to about 70° C.; and about 60° C. to about 70° C. In one particular embodiment, the mold release temperature may be about 25° C. In yet another embodiment the mold release temperature may be about 70° C.

### BRIEF DESCRIPTION OF DRAWINGS

The accompanying drawings illustrate a disclosed embodiment and serve to explain the principles of the disclosed embodiment. It is to be understood, however, that the drawings are designed for purposes of illustration only, and not as a definition of the limits of the invention.

FIG. 1 schematically illustrates a disclosed process of forming a double-sided mold which is then used to simultaneously imprint two polymer structures, in accordance with one disclosed embodiment.

FIG. 2 shows SEM images of a double-sided ETFE mold fabricated using the disclosed method. FIG. 2(a) shows an SEM image of the double-sided ETFE mold having a defined surface pattern on both sides of the mold at a magnification of 600. FIG. 2(b) shows an SEM middle-section of one side of the double-sided ETFE mold at a magnification of 3,500. FIG. 2(c) shows an SEM image of another side of the double-sided ETFE mold at a magnification of 1,800.

FIG. 3 shows SEM images of imprinted polymer structures (PMMA) fabricated using the disclosed method. FIG. 3(a) shows a top-view SEM image of one imprinted polymer structure fabricated from one side of the double-sided ETFE mold at a magnification of 2,000. FIG. 3(b) shows a top-view SEM image of another imprinted polymer structure (PMMA) fabricated from the second side of the double-sided ETFE mold at a magnification of 2,200.

FIG. 4 shows SEM images of imprinted polymer structures (PMMA) fabricated using the disclosed method. FIG. 4(a) shows a tilted view SEM image of a first imprinted polymer structure fabricated from one side the double-sided ETFE mold at a magnification of 2,500. FIG. 4(b) shows a tilted view SEM image of a second imprinted polymer structure (PMMA) fabricated from another side of the double-sided ETFE mold at a magnification of 2,500.

FIG. 5 shows SEM images of a double-sided ETFE mold fabricated using the disclosed method. FIG. 5(a) shows an SEM image of the double-sided ETFE mold showing two distinct surfaces at a magnification of 43. FIG. 5(b) shows an SEM image of one side of the double-sided ETFE mold at a magnification of 5,000. FIG. 5(c) shows an SEM image of another side of the double-sided ETFE mold at a magnification of 5,000.

FIG. 6 shows SEM images of imprinted polymer structures (PMMA) fabricated using the disclosed method. FIG. 6(a) shows a top-view SEM image of one imprinted polymer structure fabricated from one side of the double-sided ETFE mold at a magnification of 5,000. FIG. 6(b) shows a top-view SEM image of another imprinted polymer structure fabricated from the second side of the double-sided ETFE mold at a magnification of 5,000.

### DETAILED DISCLOSURE OF EXEMPLARY EMBODIMENT

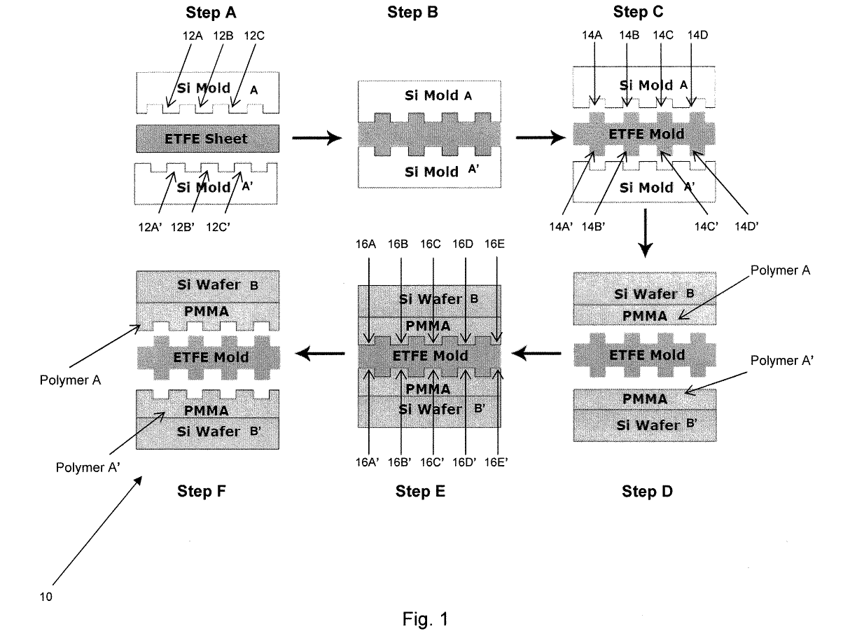

Referring to FIG. 1, there is disclosed a schematic illustration of a disclosed process 10 for simultaneously imprinting two polymer structures. In Step (A), a first Si mold A having an imprinted surface pattern consisting of projections (12A, 12B, 12C), which extend along the length of the Si mold A, is aligned directly above a first side of an ETFE sheet. A second Si mold A′ having an imprinted surface pattern consisting of projections (12A′, 12B′ 120′), which extend along the length of the Si mold A′, is aligned directly below a second side of the substrate, opposite to the first side.

In Step (B) of FIG. 1, Si mold A and Si mold A′ are pressed towards the first side and second side of the ETFE sheet respectively, at a temperature of 210° C., at 3 MPa for 20 minutes to form an ETFE mold. The ETFE mold defines a surface pattern consisting of projections (14A, 14B, 14C, 14D) on the first side and a surface pattern consisting of projections (14A′, 14B′, 14C′ 14D′) on the second side, opposite to the first side.

In Step (C) of FIG. 1, the ETFE mold is cooled to a temperature of 70° C., before releasing the ETFE mold from the Si mold A and the Si mold A′.

Referring to Step (D) of FIG. 1, the polymer A and polymer A′ are spun coated onto Si wafer B and Si wafer B′ respectively. The ETFE mold is disposed between polymer A and polymer A′. Polymer A is aligned directly above the first side of ETFE mold having a surface pattern consisting projections (14A, 14B, 14C, 14D). Polymer A′ is aligned directly below the second side of the ETFE mold, opposite to the first side and having a surface pattern consisting of projections (14A′, 14B′, 14C′ 14D′).

In Step (E) of FIG. 1, Polymer A and Polymer A′ are pressed towards the first side and second side of the ETFE mold respectively, at a temperature of 150° C., at 3 MPa for 5 minutes to form an imprint on Polymer A, having a surface pattern consisting of projections (16A, 16B, 16C, 16D, 16E) and an imprint on Polymer A′, having a surface pattern consisting of projections (16A′, 16B′, 16C′, 16D′, 16E′).

Referring to Step (F) of FIG. 1, the Polymer A and Polymer A′ are cooled to a temperature of 70° C., before releasing the Polymer A and Polymer A′ from the ETFE mold.

### EXAMPLES

Non-limiting examples of the invention will be further described in greater detail by reference to specific Examples, which should not be construed as in any way limiting the scope of the invention.

### Example 1

### Double-Sided ETFE Mold Replication

The process of the following experiments was the same process 10 with reference to FIG. 1 as described above. A double-sided ethylene(tetrafluoroethylene) (ETFE) mold is replicated according to the process disclosed below.

The masters used for the mold replication process were made of silicon. The material for the replicated mold is a commercial available ETFE sheet (Texlon obtained from Vector Foiltec, London UK). The thickness of the ETFE sheet is 0.25 mm. The mold replication process was carried out with the nanoimprinter machine (Obducat Sweden). The ETFE sheet was cut into a slightly bigger rectangular piece than the size of the silicon mold, cleaned in acetone held in an ultrasonic bath, rinsed with iso-propanol and dried with nitrogen. The ETFE sheet was sandwiched in between two silicon maters. The mold replication imprinting process was carried out at the temperature of 210° C. and with the pressure of 30 bars (3 Mpa) for 20 minutes. After that, it was cooled down to 70° C. before the pressure was released. The replica is then demolded carefully from the silicon mold. The patterned area of both surfaces of the ETFE mold was 1 cm×1 cm.

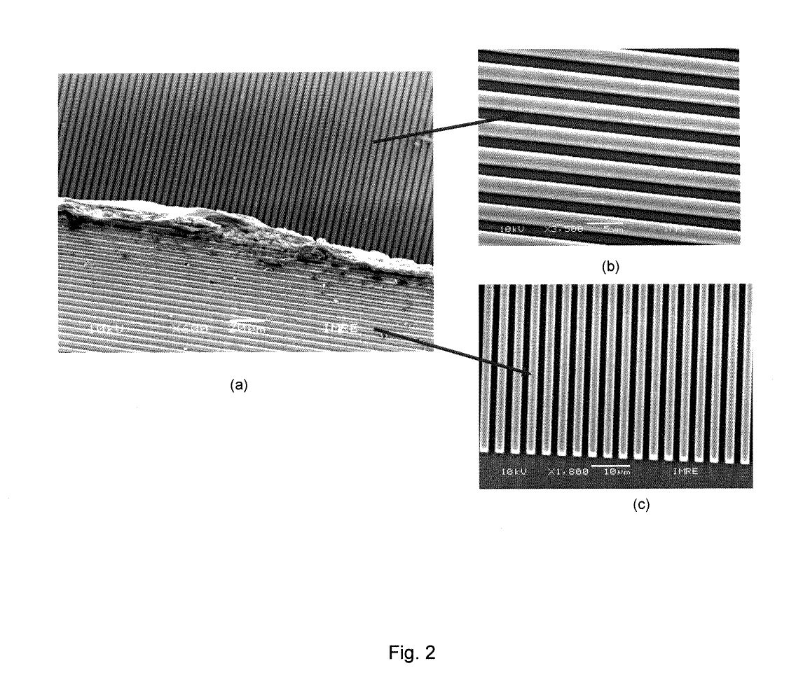

Referring to FIG. 2, there is shown a double-sided ETFE mold having a defined surface pattern on both sides of the ETFE mold consisting of a plurality of channel formations, each of which is defined between a pair of projections extending from the base of the substrate. Each projection having a length dimension extending along a longitudinal axis, a height dimension and a width dimension normal to the longitudinal axis.

The channels of the projections on both sides of the ETFE mold are 2 μm in width. FIG. 2(c) also shows that the imprinted surface pattern is well defined along the edge of the ETFE mold.

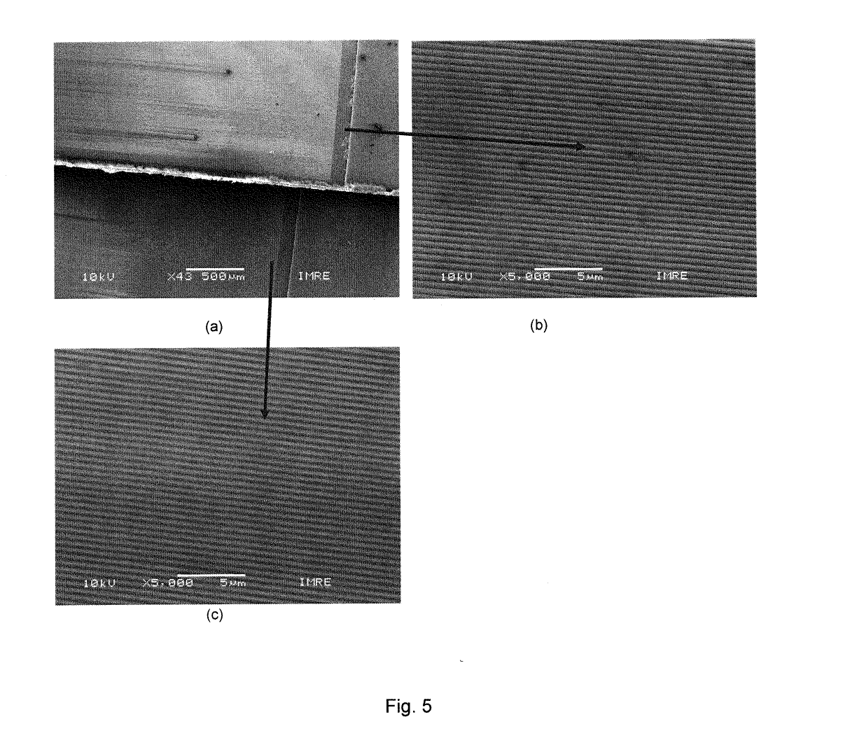

Referring to FIG. 5(a), there is shown an ETFE sheet having two distinct surfaces. FIG. 5(b) and (c) show the defined imprinted surface pattern on both sides of the ETFE mold. The widths of the channels on both sides of the ETFE mold are 250 nm.

Accordingly, both FIGS. 2 and 5 show that the ETFE sheet is mechanically conformable and thermally stable because ETFE molds of different pattern sizes can be imprinted using the methods disclosed herein.

Hence, the use of ETFE sheets allows different types of polymer structures to be imprinted.

### Example 2

### PMMA Imprinting

Bare silicon wafers were sonicated with acetone and then iso-propanol (IPA) and then further cleaned to enhance the hydrophilicity of the surface with oxygen plasma. The protocol used for the plasma cleaning was 250 mTorr pressure, RF power of 100 and oxygen flow rate of 10 sccm for 10 minutes. PMMA (M_{W}=35 k) resin from Micro Resist Technology was spun coated on the bare silicon substrates. Upon completion of the spin-coating process, the substrates were baked on the hot plate at 140° C. for 2 minutes. The ETFE soft mold was then sandwiched in between two PMMA coated substrates. The imprinting process was carried out at 150° C. for five minutes with 30 bars (3 MPa) of pressure. The sample was demolded at temperature of 70° C.

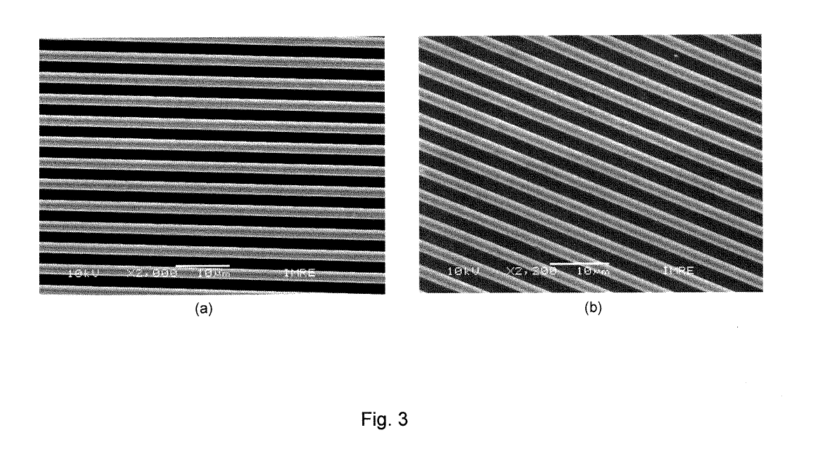

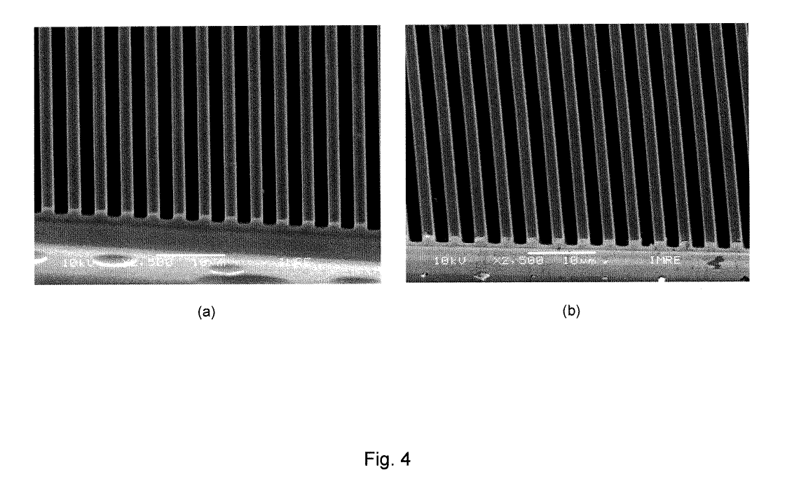

The double-sided imprinted ETFE mold obtained from Example 1 was sandwiched between two PMMA coated substrates to form two PMMA imprinted structures as shown in FIGS. 3, 4, and 6. Referring to FIGS. 3 and 4, two PMMA imprinted structures were produced from different sides of the 2 μm channel width double-sided ETFE mold.

The pattern of the imprinted surface pattern of the PMMA imprinted structures correspond to the imprint patterns of the double-sided imprinted ETFE mold as a result of the pressing step. Therefore the PMMA imprinted structures had a channel width of 2 μm. The PMMA imprinted structures in FIGS. 3 and 4 show well-defined structures which are easily fabricated with high accuracy.

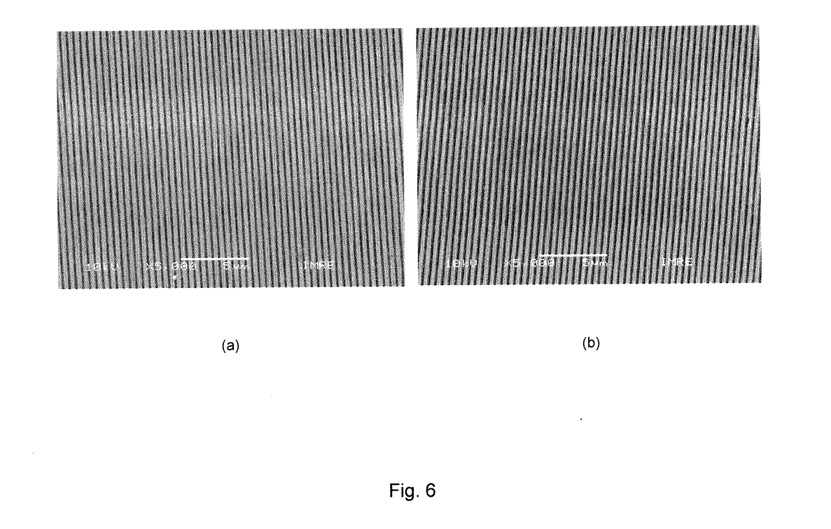

Referring to FIG. 6, two PMMA imprinted structures are formed from different sides of the 250 nm double-sided ETFE mold obtained from Example 1. Hence, the channel width of the imprinted surface pattern of the PMMA imprinted structures is 250 nm.

Accordingly, FIGS. 3 and 6 show that at least two PMMA imprinted structures can be produced at the same time, using a double-sided imprinted ETFE mold.

### Applications

The disclosed process provides a method for making an imprint on polymer structures and a method for making a double-sided imprinted substrate mold that can be used for imprinting polymers.

Advantageously, the use of a double-sided imprinted substrate mold may increase the production of polymer structures by two fold when the pressing steps occur simultaneously. This significantly reduces the costs incurred when imprinting polymer structures using the methods disclosed herein.

Advantageously, the methods disclosed herein avoid the need for additional equipment or processes, as only a single double-sided imprinted substrate mold is required to improve the throughput.

The defined imprinted surface pattern on one side of the mold can be distinct from that of the second mold. This allows a double-sided substrate mold to be imprinted, having a defined imprinted surface pattern on the first side that is distinct from the defined imprinted surface pattern on the opposite side.

Advantageously, the double-sided imprinted substrate mold disclosed herein allows at least two different types of polymer structures to be imprinted in a single imprint process.

Advantageously, the use of the imprinted substrate mold disclosed herein can be used for subsequent imprinting of similar or different polymer structures. The use of the imprinted substrate mold is advantageous over the use of hard molds due to its ability to be malleable and to distribute the applied pressure over the imprint area. Furthermore the imprinted substrate mold disclosed herein is mechanically conformable, thermally stable and is able to resist pressures and temperatures during the imprinting process.

Advantageously, no additional surface treatment such as an anti-adhesive layer is needed to coat the imprinted substrate mold disclosed herein due to its low surface energy for easy substrate release from the formed imprinted polymer structures.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A method of making an imprint on a polymer structure comprising the steps of:
a) providing an imprinted substrate mold having a defined imprinted surface pattern on a first side and a defined imprinted surface pattern on a second side, opposite to the first side;
b) pressing a polymer structure against the first side of the imprinted substrate mold to form an imprint thereon; and
c) pressing another polymer structure against the second side of the imprinted substrate mold to form an imprint thereon.

2. A method as claimed in claim 1, wherein the imprinted surface pattern on said imprinted substrate mold are nano-sized or micro-sized to thereby form nano-sized or micro-sized imprints on the polymer structure.

3. A method as claimed in claim 1, wherein said pressing step (b) and said pressing step (c) occur simultaneously.

4. A method as claimed in claim 1, wherein the imprinted substrate mold is comprised of halogenated polymer.

5. A method as claimed in claim 4, wherein the halogenated polymer is a fluorinated polymer.

6. A method as claimed in claim 5 wherein the fluorinated polymer is selected from the group consisting of polytetrafluoroethylene (PTFE), ethylene tetrafluoroethylene (ETFE), perfluoroalkyl (PFA), fluorinated ethylene-propylene copolymer (FEP), polyvinylidene fluoride (PVDF), polychlorotrifluoroethylene (PCTFE), hexafluoropropylene, chlorotrifluoroethylene, bromotrifluoroethylene and combinations thereof.

7. A method as claimed in claim 6 wherein the fluorinated polymer is ethylene tetrafluoroethylene (ETFE).

8. A method as claimed in claim 1, wherein the defined imprinted surface pattern on the first side of the imprinted substrate mold is identical to, or distinct from, the defined imprinted surface pattern on the second side, opposite to the first side of the imprinted substrate mold.

9. A method as claimed in claim 1, wherein the polymer structures are comprised of thermoplastic polymer.

10. A method as claimed in claim 9, wherein the thermoplastic polymer is selected from the group consisting of polymethyl methacrylate (PMMA), polycarbonate (PC), polyvinylacetate (PVAc), Biaxially Oriented Poly Propylene (BOPP), polystyrene (PS), polypropylene, polyethylene (PE), High-Density Polyethylene (HDPE), polystyrene, polymethyl methacrylate, poly(amides), polyacryl, poly(butylene), poly(pentadiene), polyvinyl chloride, polycarbonate, polyethylene terephthalate, polybutylene terephthalate, polysulfone, polyimide, cellulose, cellulose acetate, ethylene-propylene copolymer, ethylene-butene-propylene terpolymer, polyoxazoline, polyethylene oxide, polypropylene oxide, polyvinylpyrrolidone, and combinations thereof; an elastomer, polymer blend and copolymer selected from the group consisting of poly-dimethylsiloxane (PDMS), poly(isoprene), poly(butadiene), and combinations thereof.

11. A method as claimed in claim 10 wherein the thermoplastic polymer comprises polymethyl methacrylate (PMMA).

12. A method as claimed in claim 1 wherein the pressing steps (b) and (c) are performed at a temperature in the range of 120° C. to 180° C.; at a pressure in the range of 1 MPa to 3 MPa; and for a time in the range of 2 minutes to 10 minutes.

13. A method of making a double-sided imprinted substrate mold comprising the steps of:
a) pressing a mold having a defined imprinted surface pattern against a first side of a substrate to form a first-sided imprint mold on the substrate; and
b) pressing another mold having a defined imprinted surface pattern against a second side, opposite to the first side, of said substrate to form a second-sided imprint mold on the substrate to thereby form the double-sided imprinted substrate mold.

14. A method as claimed in claim 13, wherein the imprinted surface pattern on said molds are nano-sized or micro-sized to thereby form nano-sized or micro-sized imprints on the double-sided imprinted substrate mold.

15. A method as claimed in claim 13, wherein said pressing step (a) and said pressing step (b) occur simultaneously.

16. A method, as claimed in claim 13, wherein the double-sided imprinted substrate mold is comprised of halogenated polymer.

17. A method as claimed in claim 16, wherein the halogenated polymer is a fluorinated polymer.

18. A method as claimed in claim 17 wherein the fluorinated polymer is selected from the group consisting of polytetrafluoroethylene (PTFE), ethylene tetrafluoroethylene (ETFE), perfluoroalkyl (PFA), fluorinated ethylene-propylene copolymer (FEP), polyvinylidene fluoride (PVDF), polychlorotrifluoroethylene (PCTFE), hexafluoropropylene, chlorotrifluoroethylene, bromotrifluoroethylene and combinations thereof.

19. A method as claimed in claim 17 wherein the fluorinated polymer is ethylene tetrafluoroethylene (ETFE).

20. A method as claimed in claim 13, wherein the defined imprinted surface pattern of the first mold is identical to, or distinct from, the defined imprinted surface pattern of the second mold.

21. A method as claimed in claim 13 wherein said mold is selected from the group consisting of silicon, metal, ceramic, polymeric and combinations thereof.

22. A method as claimed in claim 21 wherein said mold comprises silicon.

23. A method as claimed in claim 13 wherein the pressing steps (a) and (b) are performed at a temperature in the range of 200° C. to 220° C.; at a pressure in the range of 3 MPa to 6 MPa; and for a time in the range of 10 minutes to 30 minutes.

24. A method for manufacturing an imprinted polymer structure comprising the steps of:
a) pressing a mold having a defined imprinted surface pattern against a first side of a substrate to form a first-sided imprint mold on the substrate;
b) pressing another mold having a defined imprinted surface pattern against a second side, opposite to the first side, of said substrate to form a second sided imprint mold on the substrate and thereby form the double-sided imprinted substrate mold;
c) pressing a polymer structure against a first side of the double-sided imprinted substrate mold to form an imprint thereon; and
d) pressing another polymer structure against the second side of the double-sided imprinted substrate mold to form an imprint thereon.

25. A method as claimed in claim 24, wherein the imprinted surface pattern on said molds are nano-sized or micro-sized to form nano-sized or micro-sized imprints on the double-sided imprinted substrate and thereby form nano-sized or micro-sized imprints on the polymer structure.

26. A method as claimed in claim 24 wherein said pressing step (a) and said pressing step (b) occur simultaneously.

27. A method as claimed in claim 24 wherein said pressing step (c) and said pressing step (d) occur simultaneously.

28. A method as claimed in claim 24 wherein said substrate is comprised of halogenated polymer.

29. A method as claimed in claim 28, wherein the halogenated polymer is a fluorinated polymer.

30. A method as claimed in claim 29 wherein said fluorinated polymer is selected from the group consisting of polytetrafluoroethylene (PTFE), ethylene tetrafluoroethylene (ETFE), perfluoroalkyl (PFA), fluorinated ethylene-propylene copolymer (FEP), polyvinylidene fluoride (PVDF), polychlorotrifluoroethylene (PCTFE), hexafluoropropylene, chlorotrifluoroethylene, bromotrifluoroethylene and combinations thereof.

31. A method as claimed in claim 30 wherein the fluorinated polymer is ethylene tetrafluoroethylene (ETFE).

32. A method as claimed in claim 24 wherein the defined imprinted surface pattern of the first mold is identical, to or distinct from, the defined imprinted surface pattern of the second mold.

33. A method as claimed in claim 24 wherein the defined imprinted surface pattern on the first side of the double-sided imprinted substrate mold is identical to, or distinct from, the defined imprinted surface pattern on the second side, opposite to the first side of the double-sided imprinted substrate mold.

34. A method as claimed in claim 24 wherein the polymer structures are comprised of thermoplastic polymer.

35. A method as claimed in claim 34, wherein the thermoplastic polymer is selected from the group consisting of polymethyl methacrylate (PMMA), polycarbonate (PC), polyvinylacetate (PVAc), Biaxially Oriented Poly Propylene (BOPP), polystyrene (PS), polypropylene, polyethylene (PE), High-Density Polyethylene (HDPE), polystyrene, polymethyl methacrylate, poly(amides), polyacryl, poly(butylene), poly(pentadiene), polyvinyl chloride, polycarbonate, polyethylene terephthalate, polybutylene terephthalate, polysulfone, polyimide, cellulose, cellulose acetate, ethylene-propylene copolymer, ethylene-butene-propylene terpolymer, polyoxazoline, polyethylene oxide, polypropylene oxide, polyvinylpyrrolidone, and combinations thereof; an elastomer, polymer blend and copolymer selected from the group consisting of poly-dimethylsiloxane (PDMS), poly(isoprene), poly(butadiene), and combinations thereof.

36. A method as claimed in claim 35 wherein the thermoplastic polymer comprises polymethyl methacrylate (PMMA).

37. A method as claimed in claim 24 wherein the mold is selected from the group consisting of silicon, metal, ceramic, polymeric and combinations thereof.

38. A method as claimed in claim 37 wherein said mold comprises silicon.

39. A method as claimed in claim 24 wherein the pressing steps (a) and (b) are performed at a temperature in the range of 200° C. to 220° C.; at a pressure in the range of 3 MPa to 6 MPa; and for a time in the range of 10 minutes to 30 minutes.

40. A method as claimed in claim 24 wherein the pressing steps (c) and (d) are performed at a temperature in the range of 120° C. to 180° C.; at a pressure in the range of 1 MPa to 3 MPa; and for a time in the range of 2 minutes to 10 minutes.

41. An imprinted polymer structure, the imprinted polymer structure made in a method comprising the steps of:
a) providing an imprinted substrate mold having a defined imprinted surface pattern on a first side and a defined imprinted surface pattern on a second side, opposite to the first side;
b) pressing a polymer structure against the first side of the imprinted substrate mold to form an imprint thereon; and
c) pressing another polymer structure against the second side of the imprinted substrate mold to form an imprint thereon.

42. A nano-sized or micro-sized imprinted polymer structure made in the method as claimed in claim 2.

43. A nano-sized or micro-sized imprinted polymer structure made in the method as claimed in claim 25.

44. A double-sided imprinted substrate mold, the double-sided imprinted substrate mold made in a method comprising the steps of:
a) pressing a mold having a defined imprinted surface pattern against a first side of a substrate to form a first-sided imprint mold on the substrate; and
b) pressing another mold having a defined imprinted surface pattern against a second side, opposite to the first side, of said substrate to form a second-sided imprint mold on the substrate to thereby form the double-sided imprinted substrate mold.

45. A double-sided nano-sized or micro-sized imprinted substrate mold made in the method as claimed in claim 14.

46. Use of a double-sided imprinted substrate mold for imprinting at least two polymer structures.

47. Use of a double-sided nano-sized or micro-sized imprinted substrate mold for imprinting at least two nano-sized or micro-sized polymer structures.
